(19) United States
(12) Patent Application Publication
(10) Pub. No.: US 2024/0092442 A1
(43) Pub. Date: Mar. 21, 2024

(54) STORAGE DEVICE FOR BICYCLE

(71) Applicant: Louis CHUANG, Taichung (TW)

(72) Inventor: Louis CHUANG, Taichung (TW)

(21) Appl. No.: 18/297,121

(22) Filed: Apr. 7, 2023

(30) Foreign Application Priority Data
Sep. 15, 2022 (TW) 111134958

(51) Int. Cl. B62J 9/22

(52) U.S. Cl. CPC B62J 9/22

(57) ABSTRACT

A storage device includes a rack and a storage bag assembly. The rack has a top surface and a bottom surface opposite to the top surface in a height direction. The rack defines a first side and a second side opposite to the first side arranged on an outer periphery thereof in a horizontal direction, and the rack is provided with a plurality of engaging slots distributed on either the first side or the second side. The storage bag assembly is detachably connected to the top surface. The storage bag assembly is provided with a plurality of engaging portions, which are engaged in the plurality of engaging slots and abutted against the bottom surface when the storage bag assembly detachably connected to the rack.

### BACKGROUND OF THE INVENTION

The present invention relates to a storage device and, more particularly, to a storage device for a bicycle.

U.S. Pat. No. 9,840,295 discloses a bicycle bag including a bag body and at least one adjusting belt assembly. The bag body is adapted to store bicycle accessories and includes a first penetration portion and a second penetration portion. The at least one adjusting belt assembly is selectively inserted through one of the first and second penetration portions to form a suspending portion attachable to a bicycle. Thus, the bicycle bag can be attached to an up tube or a seat post of a bicycle, or attached between the saddle and the seat post of a bicycle to meet user needs.

However, the above bicycle bag is attached to the bicycle by adjusting the belt assembly for hanging. This attaching method causes inconvenience in use as the adjusting belt assembly needs to be readjusted every time the bicycle bag is attached to or removed from the bicycle.

Thus, a need exists for a storage device to mitigate and/or obviate the above disadvantages.

### SUMMARY OF THE INVENTION

An objective of the present invention is to provide a storage device that includes a rack and a storage bag assembly. The rack has a top surface and a bottom surface opposite to the top surface in a height direction. The rack defines a first side and a second side opposite to the first side in a width direction. The rack is provided with a plurality of engaging slots distributed on either the first side or the second side. The storage bag assembly is detachably connected to the top surface of the rack, and the storage bag assembly is provided with a plurality of engaging portions. When the storage bag assembly is connected to the rack, the plurality of engaging portions are engaged in the plurality of engaging slots and abutted against the bottom surface.

In an embodiment, the rack is provided with an even number of engaging slots arranged in pairs and symmetrically on the first side and the second side, and the storage bag assembly is provided with an even number of engaging portions. When the storage bag assembly is connected to the rack, the even number of engaging portions are engaged in the even number of engaging slots and abutted against the bottom surface.

In an embodiment, the storage device further includes a plurality of binding straps respectively looping around the top surface and the bottom surface and sleeving on the rack. When the storage bag assembly is connected to the rack, the storage bag assembly covers sides of the plurality of binding straps opposite to the top surface. When the storage bag assembly is detached from the rack, the plurality of binding straps is flexibly deformed to stretch or shrink.

In an embodiment, the rack is further provided with a plurality of recesses extending through the top surface, the first side, the bottom surface, and the second side to surround around the rack. The plurality of binding straps are respectively arranged in the plurality of recesses.

In an embodiment, the rack defines a first end and a second end opposite to the first end in a length direction. The rack is further provided with an elongated slot arranged on the top surface and extended from the first end to the second end. The storage bag assembly is further provided with a limiting portion being flexibly deformable. When the storage bag assembly is connected to the rack, the limiting portion is arranged in the elongated slot and abuts against a side wall of the elongated slot adjacent to the first end.

In an embodiment, the storage bag assembly is further provided with a connecting member and a bag member. The plurality of engaging portions and the limiting portion are disposed at a bottom edge of the connecting member. The bag member is connected to a top edge of the connecting member.

In an embodiment, the rack is connected with two fixing straps. The two fixing straps are respectively connected to the bottom surface. One of the two fixing straps is adjacent to the first end and the other fixing strap is adjacent to the second end.

In another embodiment, the rack is connected with two locking members. Each of the two locking members has a threaded portion arranged on an outer periphery thereof. The two locking members respectively penetrate through the top surface and are exposed on the bottom surface.

The present invention will become clearer in light of the following detailed description of illustrative embodiments of this invention described in connection with the drawings.

### BRIEF DESCRIPTION OF DRAWINGS

FIG. 1 is a perspective view of a storage device of a first embodiment according to the present invention.

FIG. 2 is an exploded perspective view of the storage device of FIG. 1.

FIG. 3 is another exploded perspective view of the storage device of FIG. 1.

FIG. 4 is a cross sectional view of the storage device of FIG. 1.

FIG. 5 is another cross sectional view of the storage device of FIG. 1.

FIG. 6 is a perspective view of a storage device of a first embodiment according to the present invention and shows the storage device mounted to a bicycle.

FIG. 7 is a cross sectional view of a storage device of a second embodiment according to the present invention.

### DETAILED DESCRIPTION OF THE INVENTION

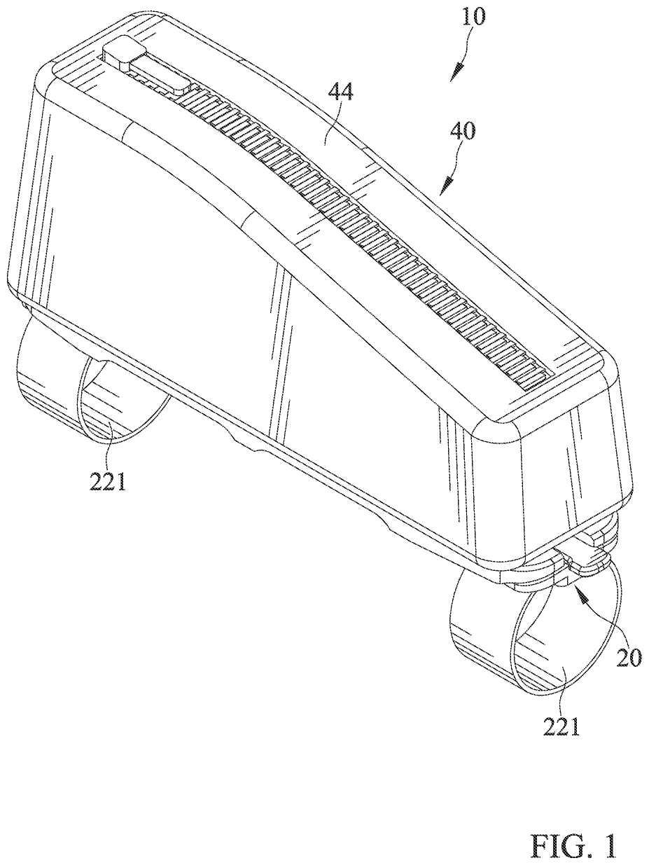

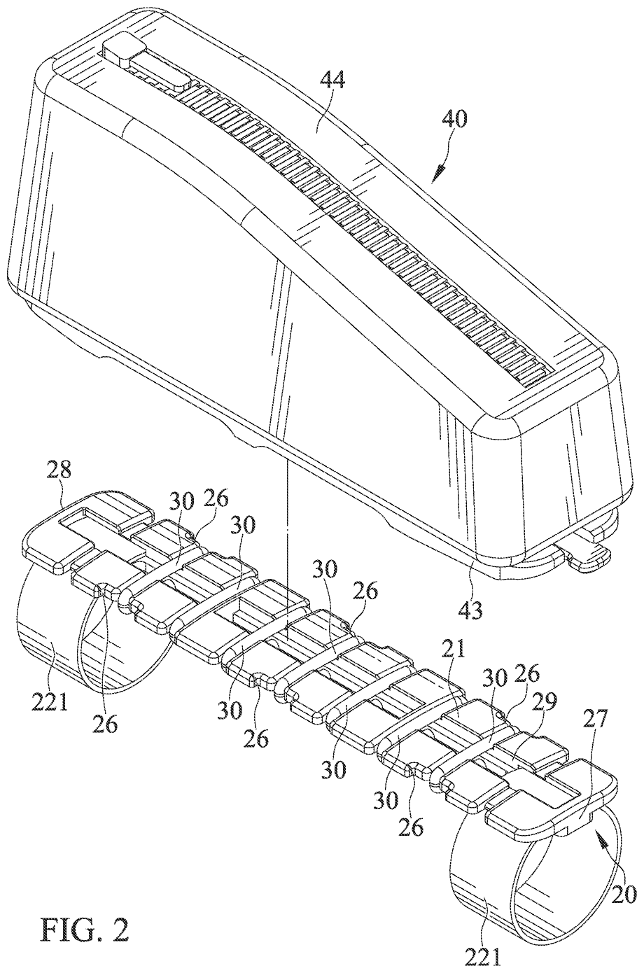

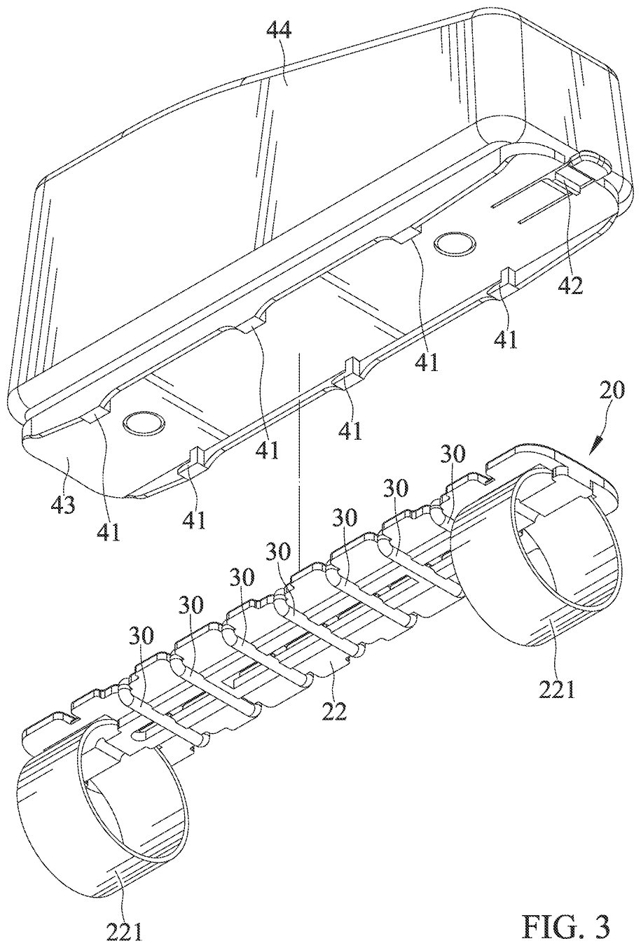

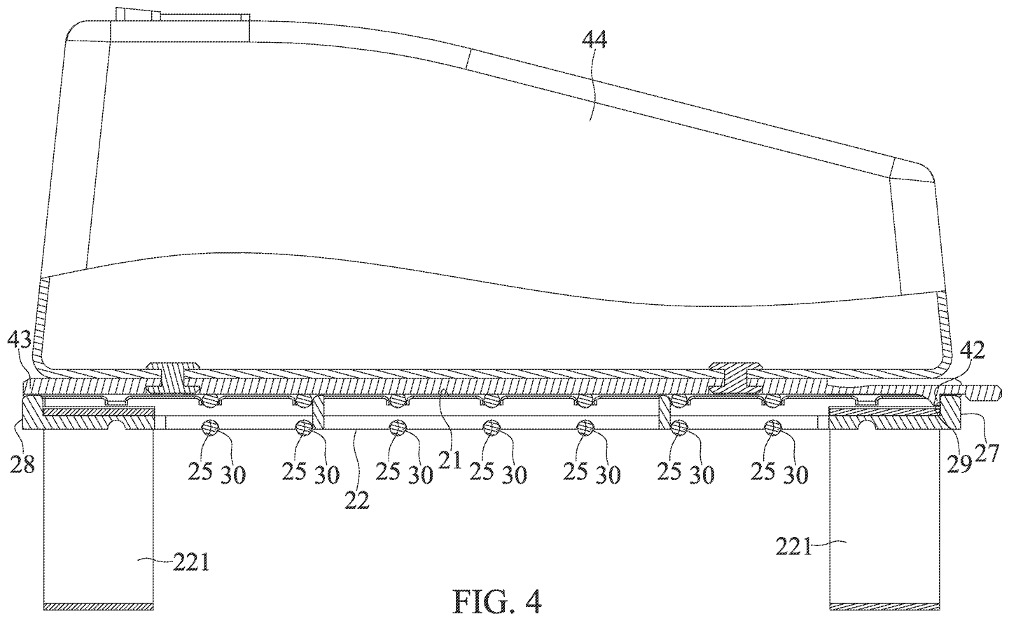

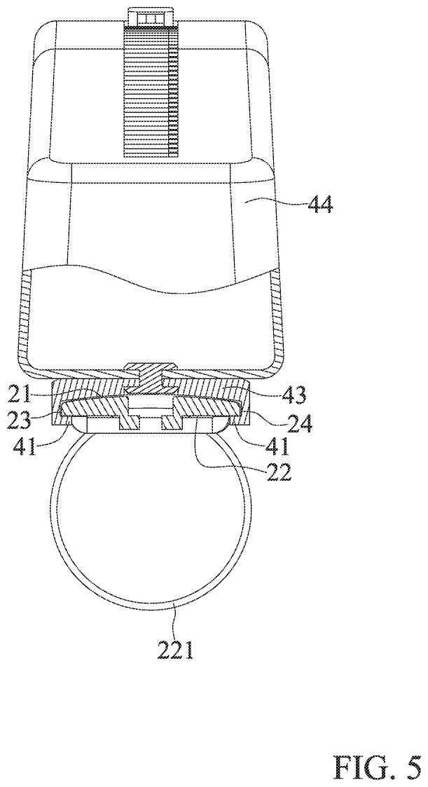

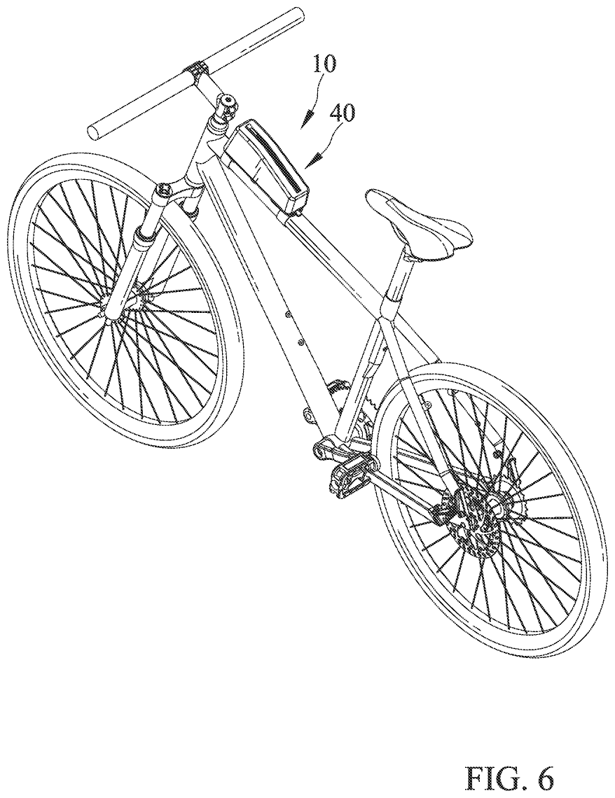

FIGS. 1-6 show a storage device 10 of a first embodiment according to the present invention. The storage device 10 includes a rack 20, a plurality of binding straps 30 and a storage bag assembly 40.

The rack 20 has a top surface 21 and a bottom surface 22 opposite to the top surface 21 in a height direction.

The plurality of binding straps 30 respectively loop around the top surface 21 and the bottom surface 22 and sleeve on the rack 20.

The storage bag assembly 40 is detachably connected to the top surface 21 of the rack 20. When the storage bag assembly 40 is connected to the rack 20, the storage bag assembly 40 covers sides of the plurality of binding straps 30 opposite to the top surface 21. When the storage bag assembly 40 is detached from the rack 20, the plurality of binding straps 30 is flexibly deformed to stretch or shrink.

The rack 20 defines a first side 23 and a second side 24 opposite to the first side 23 in a width direction. The rack 20 is further provided with a plurality of recesses 25 extending through the top surface 21, the first side 23, the bottom surface 22, and the second side 24 to surround around the rack 20, and the plurality of binding straps 30 are respectively arranged in the plurality of recesses 25.

The rack 20 is provided with a plurality of engaging slots 26 distributed on either the first side 23 or the second side 24. The storage bag assembly 40 is provided with a plurality of engaging portions 41. When the storage bag assembly 40 is connected to the rack 20, the plurality of engaging portions 41 are engaged in the plurality of engaging slots 26 and abutted against the bottom surface 22.

The rack 20 of this embodiment is provided with an even number of engaging slots 26 arranged in pairs and symmetrically on the first side 23 and the second side 24. The storage bag assembly 40 is provided with an even number of engaging portions 41. When the storage bag assembly 40 is connected to the rack 20;20a, the even number of engaging portions 41 are engaged in the even number of engaging slots 26 and abutted against the bottom surface 22.

The rack 20 defines a first end 27 and a second end 28 opposite to the first end 27 in a length direction. The rack 20 is further provided with an elongated slot 29 arranged on the top surface 21 and extended from the first end 27 to the second end 28. The storage bag assembly 40 is further provided with a limiting portion 42 being flexibly deformable. When the storage bag assembly 40 is connected to the rack 20, the limiting portion 42 is arranged in the elongated slot 29 and abuts against a side wall of the elongated slot 29 adjacent to the first end 27.

The storage bag assembly 40 is further provided with a connecting member 43 and a bag member 44. The plurality of engaging portions 41 and the limiting portion 42 are disposed at a bottom edge of the connecting member 43, and the bag member 44 is connected to a top edge of the connecting member 43.

The rack 20 is connected with two fixing straps 221, which are respectively connected to the bottom surface 22. One of the two fixing straps 221 is adjacent to the first end 27 and the other fixing strap 221 is adjacent to the second end 28.

Thus, the storage device 10 can provide a storage bag assembly 40 that can be quickly attached and detached to a bicycle. The rack 20 can be attached to the bicycle frame through the two fixing straps 221, and the storage bag assembly 40 can be attached to the bicycle through the rack 20. The storage bag assembly 40 can be quickly attached to or detached from the bicycle, and the binding straps 30 can also be used to tie objects.

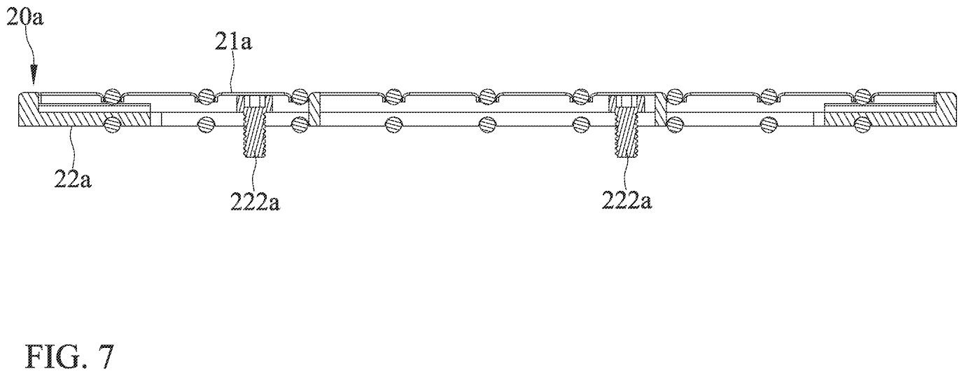

FIG. 7 shows a storage device 10 of a second embodiment according to the present invention. The second embedment is substantially the same as the first embodiment. The main differences are that the rack 20a is connected with two locking members 222a. Each of the two locking members 222a has a threaded portion arranged on an outer periphery thereof. The two locking members 222a respectively penetrate through the top surface 21a and are exposed on the bottom surface 22a.

Although specific embodiments have been illustrated and described, numerous modifications and variations are still possible without departing from the scope of the invention. The scope of the invention is limited by the accompanying claims.

1. A storage device comprising:
a rack having a top surface and a bottom surface opposite to the top surface in a height direction, wherein the rack defines a first side and a second side opposite to the first side in a width direction, and wherein the rack is provided with a plurality of engaging slots distributed on either the first side or the second side; and
a storage bag assembly detachably connected to the top surface of the rack, wherein the storage bag assembly is provided with a plurality of engaging portions;
wherein when the storage bag assembly is connected to the rack, the plurality of engaging portions are engaged in the plurality of engaging slots and abutted against the bottom surface.

2. The storage device as claimed in claim 1, wherein the rack is provided with an even number of engaging slots arranged in pairs and symmetrically on the first side and the second side, wherein the storage bag assembly is provided with an even number of engaging portions;
wherein when the storage bag assembly is connected to the rack, the even number of engaging portions are engaged in the even number of engaging slots and abutted against the bottom surface.

3. The storage device as claimed in claim 1, further comprising:
a plurality of binding straps respectively looping around the top surface and the bottom surface and sleeving on the rack;
wherein when the storage bag assembly is connected to the rack, the storage bag assembly covers sides of the plurality of binding straps opposite to the top surface;
wherein when the storage bag assembly is detached from the rack, the plurality of binding straps is flexibly deformed to stretch or shrink.

4. The storage device as claimed in claim 2, wherein the rack is further provided with a plurality of recesses extending through the top surface, the first side, the bottom surface, and the second side to surround around the rack, and wherein the plurality of binding straps are respectively arranged in the plurality of recesses.

5. The storage device as claimed in claim 4, wherein the rack defines a first end and a second end opposite to the first end in a length direction, wherein the rack is further provided with an elongated slot arranged on the top surface and extended from the first end to the second end, and wherein the storage bag assembly is further provided with a limiting portion being flexibly deformable;
wherein when the storage bag assembly is connected to the rack, the limiting portion is arranged in the elongated slot and abuts against a side wall of the elongated slot adjacent to the first end.

6. The storage device as claimed in claim 4, wherein the storage bag assembly is further provided with a connecting member and a bag member, wherein the plurality of engaging portions and the limiting portion are disposed at a bottom edge of the connecting member, and wherein the bag member is connected to a top edge of the connecting member.

7. The storage device as claimed in claim 5, wherein the rack is connected with two fixing straps, wherein the two fixing straps are respectively connected to the bottom surface, and wherein one of the two fixing straps is adjacent to the first end and the other fixing strap is adjacent to the second end.

8. The storage device as claimed in claim 1, wherein the rack is connected with two locking members, wherein each of the two locking members has a threaded portion arranged on an outer periphery thereof, and wherein the two locking members respectively penetrate through the top surface and are exposed on the bottom surface.
